(19) United States
(12) Patent Application Publication
(10) Pub. No.: US 2017/0289243 A1
(43) Pub. Date: Oct. 5, 2017

(54) DOMAIN NAME RESOLUTION METHOD AND ELECTRONIC DEVICE

(71) Applicants: Le Holdings (Beijing) Co., Ltd., Beijing (CN); LeCloud Computing Co., Ltd., Beijing (CN)

(72) Inventor: Peng Zhang, Beijin (CN)

(21) Appl. No.: 15/242,526

(22) Filed: Aug. 21, 2016

Related U.S. Application Data
(63) Continuation of application No. PCT/CN2016/089538, filed on Jul. 10, 2016.

(30) Foreign Application Priority Data
Mar. 31, 2016 (CN) 2016102026679

(51) Int. Cl. H04L 29/08; H04L 29/12

(52) U.S. Cl. CPC H04L 67/1008; H04L 61/1511; H04L 61/106

(57) ABSTRACT

One embodiment of the present disclosure provides a domain name resolution method and electronic device, where the domain name resolution method includes: receiving a domain name resolution request sent by a terminal device; acquiring domain name information from the domain name resolution request and acquiring IP addresses of multiple servers corresponding to the domain name information; selecting a server with a minimum load among the multiple servers; and sending an IP address of the server with a minimum load to the terminal device, so that the terminal device accesses the server with a minimum load. The domain name resolution method and apparatus of some embodiments of the present invention implement feeding back an IP address of a server with a minimum load to a terminal device when the terminal device sends a domain name resolution request, so as to increase a speed of the terminal device accessing a network and improve network experience of a user.

### CROSS-REFERENCE TO RELATED APPLICATIONS

The present disclosure is a continuation of PCT application No. PCT/CN2016/089538 submitted on Jul. 10, 2016, and claims priority to Chinese Patent Application No. 201610202667.9, filed with the Chinese Patent Office on Mar. 31, 2016 and entitled “DOMAIN NAME RESOLUTION METHOD AND APPARATUS,” which is incorporated herein by reference in its entirety.

### TECHNICAL FIELD

The present disclosure relates to technologies of the Internet, and in particular, to a domain name resolution method and electronic device.

### BACKGROUND

A domain name system (Domain Name System, DNS) is a basic protocol of the Internet and is used to complete translation from a domain name to an internet protocol (Internet Protocol, IP) address between networks. A DNS server has the following two functions: one function is saving domain names of all hosts and corresponding IP addresses in the network; and the other function is converting domain names into IP addresses. A process of mapping domain names into IP addresses is called “domain name resolution.” One domain name may correspond to one or more IP addresses.

Usually, when a user inputs a domain name of a certain website in an address bar of a browser, the browser sends the domain name to a preset DNS server. The DNS server resolves the domain name to obtain an IP address. Domain names (such as www.le.com) of some large-scale websites mostly correspond to multiple IP addresses; any one IP address may be selected from the multiple IP addresses and returned to the user, so that the use accesses a corresponding server by the IP address. However, if a server corresponding to the IP address returned to the user is currently more heavily loaded, certainly, the server will respond slowly. Correspondingly, the terminal device also accesses the network more slowly, lowering network experience of the user.

### SUMMARY

An objective of the present invention is to provide a domain name resolution method and electronic device, to implement feeding back an IP address of a server with a minimum load to a terminal device when the terminal device sends a domain name resolution request, so as to increase a speed of the terminal device accessing a network and improve network experience of a user.

On a first aspect, an embodiment of the present disclosure provides a domain name resolution method, including: receiving a domain name resolution request sent by a terminal device; acquiring domain name information from the domain name resolution request and acquiring IP addresses of multiple servers corresponding to the domain name information; selecting a server with a minimum load among the multiple servers; and sending an IP address of the server with a minimum load to the terminal device, so that the terminal device accesses the server with a minimum load.

In one embodiment, the selecting a server with a minimum load among the multiple servers includes: separately acquiring load capacities of the multiple servers from a predetermined monitoring server; and selecting the server with a minimum load.

In one embodiment, the load capacities are obtained by at least one of a download speed, a number of connected terminals, and a download response time.

On a second aspect, an embodiment of the disclosure further provides a non-volatile computer storage medium, which stores computer executable instructions, where the computer executable instructions are used to execute any of the foregoing domain name resolution methods of the disclosure.

On a third aspect, an embodiment of the disclosure further provides an electronic device, including: at least one processor; and a memory, where the memory stores a program that can be executed by the at least one processor, and the instructions are executed by the at least one processor, so that the at least one processor can execute any of the foregoing domain name resolution methods of the disclosure.

The domain name resolution method and electronic device provided in the embodiments of the present invention, by receiving a domain name resolution request sent by a terminal device, further acquiring domain name information from the domain name resolution request, acquiring IP addresses of multiple servers corresponding to the domain name information, and selecting a server with a minimum load among the multiple servers, implement feeding back an IP address of a server with a minimum load to the terminal device, so as to increase a speed of the terminal device accessing a network and improve network experience of a user.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a flowchart showing a domain name resolution method according to Embodiment 1 of the present disclosure;

FIG. 2 is a flowchart showing a domain name resolution method according to Embodiment 2 of the present disclosure;

FIG. 3 is a logic block diagram showing a domain name resolution apparatus according to Embodiment 3 of the present disclosure;

FIG. 4 is a logic block diagram showing a domain name resolution apparatus according to Embodiment 4 of the present disclosure; and

FIG. 5 is a schematic structural diagram of hardware of a device for executing a domain name resolution method according to Embodiment 6 of the present disclosure.

### DETAILED DESCRIPTION

A basic idea of some embodiments of the present invention is to provide a technical solution of domain name resolution. Specifically, first, a domain name resolution request sent by a terminal device is received; secondly, domain name information is acquired from the domain name resolution request, and IP addresses of multiple servers corresponding to the domain name information are acquired, and further, a server with a minimum load is selected from the acquired multiple servers, to implement feeding back an IP address of a server with a minimum load to the terminal device, so as to provide a fast and smooth network environment to the terminal device, and improve network experiment of a user.

The domain name resolution method and apparatus of some exemplary embodiments of the present disclosure are described in detail with reference to accompanying drawings below.

### Embodiment 1

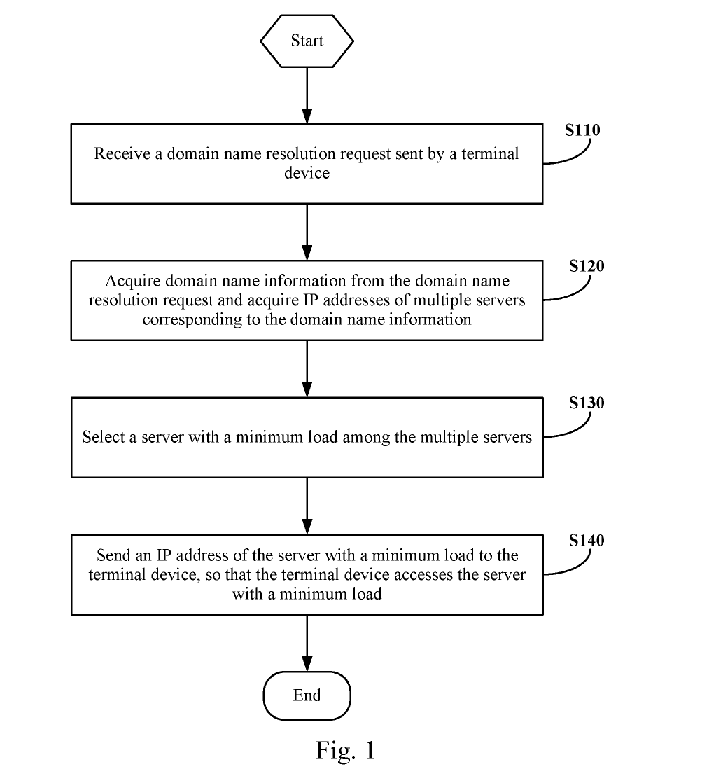

FIG. 1 is a flowchart showing a domain name resolution method according to Embodiment 1 of the present disclosure. The method may be executed on, for example, a DNS server.

Referring to FIG. 1, in step S110, a domain name resolution request sent by a terminal device is received.

When a user accesses a network by a terminal device, the user needs to input a domain name of a website to be accessed, for example, www.le.com, and then can access a server of the website. The user first sends a domain name resolution request to a DNS server by the terminal device, and the domain name resolution request is used for the DNS server to resolve the domain name.

In step S120, domain name information from the domain name resolution request is acquired and IP addresses of multiple servers corresponding to the domain name information are acquired.

In a specific implementation manner, after the domain name resolution request is received, whether a record of the domain name of the domain name resolution request exists in a DNS cache may be first detected, that is, searching the DNS cache is executed, and a record of the domain name is searched in the cache. If no record of the domain name of the domain name resolution request exists in the DNS cache, the domain name of the domain name resolution request is resolved by the DNS server. Certainly, after the domain name resolution request is received, the domain name of the domain name resolution request may be directly resolved by the DNS server, so as to obtain IP addresses of multiple servers. If a record of the domain name of the domain name resolution request exists in the DNS cache, an IP address corresponding to the domain name exists in the DNS cache. Here, the IP address may be multiple. Then IP addresses of multiple servers may be directly acquired from the DNS cache.

In step S130, a server with a minimum load among the multiple servers is selected.

For example, the above-described IP addresses of the multiple servers include two IP addresses of 1.1.1.1 and 1.1.1.2, where a server with the IP address of 1.1.1.1 has a minimum load currently, and then 1.1.1.1 is an optimal result selected by the DNS server, that is, a server with a minimum load.

In step S140, an IP address of the server with a minimum load is sent to the terminal device, so that the terminal device accesses the server with a minimum load.

The domain name resolution method provided in this embodiment of the present invention, by receiving a domain name resolution request sent by a terminal device, further acquiring domain name information from the domain name resolution request, acquiring IP addresses of multiple servers corresponding to the domain name information, and selecting a server with a minimum load among the multiple servers, implements feeding back an IP address of the server with a minimum load to the terminal device, so as to increase a speed of the terminal device accessing a network and improve network experience of a user.

### Embodiment 2

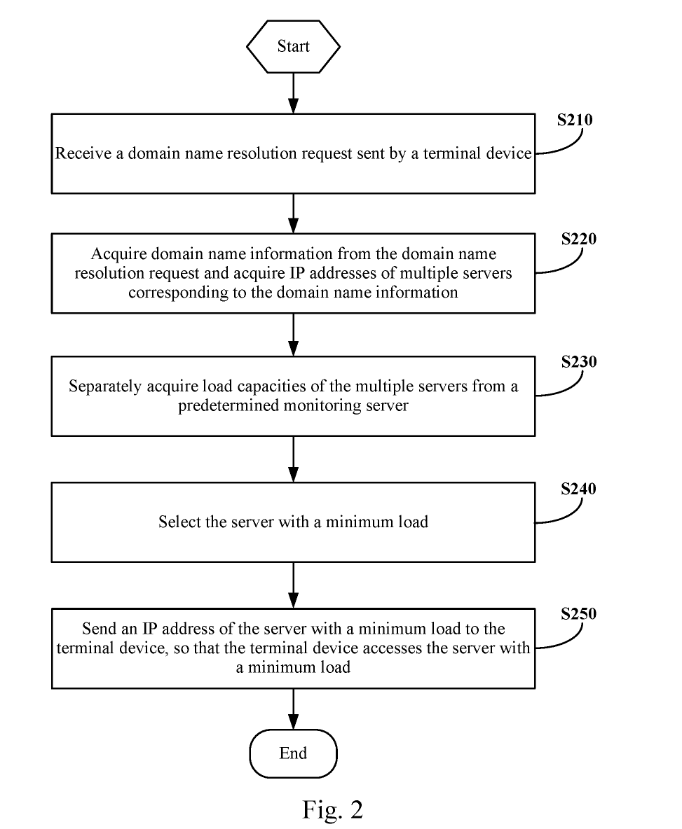

FIG. 2 is a flowchart showing a domain name resolution method according to Embodiment 2 of the present disclosure. This embodiment may be regarded as another specific implementation solution of FIG. 1. The method may be executed on the domain name resolution apparatus shown in FIG. 4.

Referring to FIG. 2, in step S210, a domain name resolution request sent by a terminal device is received.

In step S220, domain name information from the domain name resolution request is acquired and IP addresses of multiple servers corresponding to the domain name information are acquired.

Here, step S210 and step S220 respectively have the same processing manners as those of step S110 and step S120 in the above Embodiment 1. See step content of the foregoing S110 and S120 for details, which are not described in detail herein.

Step S230 and step S240 may be refinements of step S130 of the above Embodiment 1, and specifically as follows:
in step S230, load capacities of the multiple servers from a predetermined monitoring server are separately acquired.

In a specific implementation manner, a special monitoring server may be preset, and the preset monitoring server periodically sends a load state request message to various servers, and the various servers return their respective current load capacity information to the monitoring server. The forgoing processing may also be completed by the DNS server itself. If the preset monitoring server completes the foregoing processing, the DNS server needs to acquire the load capacity information of the various servers from the monitoring server. A server with a minimum load is selected according to the load capacity information of the various servers to provide a network service to a user. Besides, load capacities of the above various servers may also be stored, and the stored load capacities are updated according to feedback of the various servers at each cycle.

It should be noted that the above load capacities may be obtained by at least one of a download speed, a number of connected terminals, and a download response time, but are not limited thereto. For example, assuming that “a download response time (1.1.1.1)”=20 s, and “a download response time (1.1.1.2)=10 s,” here, a longer download response time indicates a heavier load of the server. For another example, “a number of connected terminals (1.1.1.1)”=1000, and “a number of connected terminals (1.1.1.2)=500,” the greater number of connected terminals indicates a heavier load of the server. Therefore, the load capacities of the various servers may be determined according to data capable of reflecting a load state of a server such as a number of connected terminals, a download response time, a download speed, and the like.

In step S240, a server with a minimum load is selected.

After the load capacities of the above various servers are obtained, the various servers may be ranked according to the load capacities, and a server with a minimum load is selected therefrom.

In step S250: an IP address of the server with a minimum load is sent to the terminal device, so that the terminal device accesses the server with a minimum load.

Here, step S250 has the same processing manner as that of step S140 in the forgoing Embodiment 1. See step content of the foregoing S140 for details, which is not described in details herein.

The domain name resolution method provided in some embodiments of the present invention has the following technical effects:
on one hand, the load capacities of multiple servers are acquired by a predetermined monitoring server, so as to provide a judgment basis for selection of a server with a minimum load, and to more conveniently and fast send an IP address of the server with a minimum load to the terminal device, thereby allowing the terminal device to access a network by the server with a minimum load, greatly increasing a speed for accessing the network and improving network experience of the user; and
on the other hand, the load capacities of the servers are obtained based on multidimensional data reflecting load states of the servers, such as a download speed, a number of connected terminals, and a download response time, etc., so as to accurately select a server with a minimum load.

### Embodiment 3

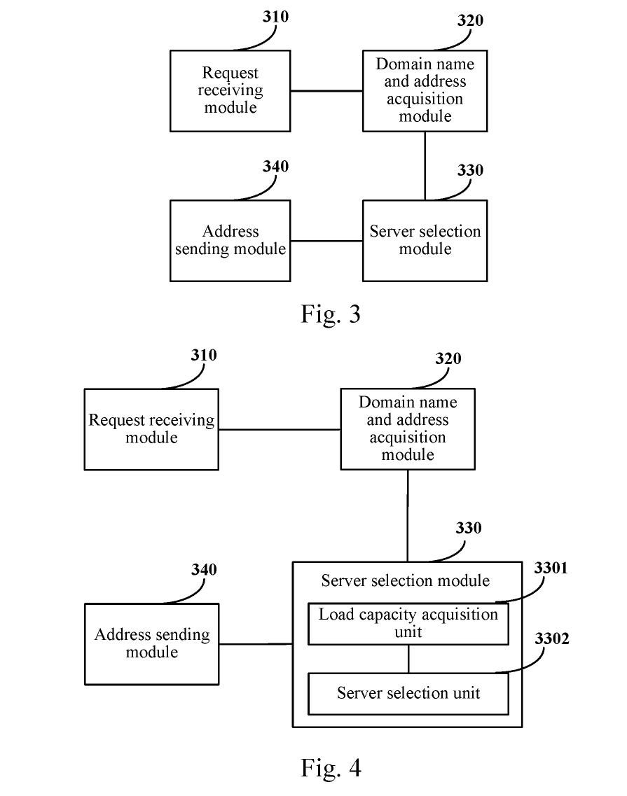

Based on the same technical idea, FIG. 3 is a logic block diagram showing a domain name resolution apparatus according to Embodiment 3 of the present disclosure. The domain name resolution apparatus may be used to execute a process of the domain name resolution method as stated in Embodiment 1.

Referring to FIG. 3, the domain name resolution apparatus includes: a request receiving module 310, a domain name and address acquisition module 320, a server selection module 330, and an address sending module 340.

The request receiving module 310 is configured to receive a domain name resolution request sent by a terminal device.

The domain name and address acquisition module 320 is configured to acquire domain name information from the domain name resolution request and acquire IP addresses of multiple servers corresponding to the domain name information.

The server selection module 330 is configured to select a server with a minimum load among the multiple servers.

The address sending module 340 is configured to send an IP address of the server with a minimum load to the terminal device, so that the terminal device accesses the server with a minimum load.

The domain name resolution apparatus provided in some embodiments of the present disclosure, by receiving a domain name resolution request sent by a terminal device, further acquiring domain name information from the domain name resolution request, acquiring IP addresses of multiple servers corresponding to the domain name information, and selecting a server with a minimum load among the multiple servers, implements feeding back an IP address of the server with a minimum load to the terminal device, so as to increase a speed of the terminal device accessing a network and improve network experience of a user.

### Embodiment 4

Based on the same technical idea, FIG. 4 is a logic block diagram showing a domain name resolution apparatus according to Embodiment 4 of the present disclosure. The domain name resolution apparatus may be used to execute a process of the domain name resolution method as stated in Embodiment 2.

Referring to FIG. 4, the server selection module 330 may specifically include:
a load capacity acquisition unit 3301 configured to separately acquire load capacities of the multiple servers from a predetermined monitoring server; and
a server selection unit 3302 configured to select a server with a minimum load.

Further, the load capacities are obtained by at least one of a download speed, a number of connected terminals, and a download response time.

The domain name resolution apparatus provided in some embodiments of the present disclosure has the following technical effects:
on one hand, the load capacities of multiple servers are acquired by a predetermined monitoring server, so as to provide a judgment basis for selection of a server with a minimum load, and to more conveniently and fast send an IP address of the server with a minimum load to the terminal device, thereby allowing the terminal device to access a network by the server with a minimum load, greatly increasing a speed for accessing the network and improving network experience of the user; and
on the other hand, the load capacities of the servers are obtained based on multidimensional data reflecting load states of the servers, such as a download speed, a number of connected terminals, and a download response time, etc., so as to accurately select a server with a minimum load.

It should be noted that according to the needs of implementations, each part/step described in this disclosure may be divided into more parts/steps, and also two or more parts/steps or some operations of parts/steps may be combined into a new part/step, so as to achieve the objective of the present disclosure.

### Embodiment 5

Embodiment 5 of the disclosure provides a non-volatile computer storage medium, which stores computer executable instructions, where the computer executable instructions can execute the domain name resolution method of any of the foregoing method embodiments of the disclosure.

### Embodiment 6

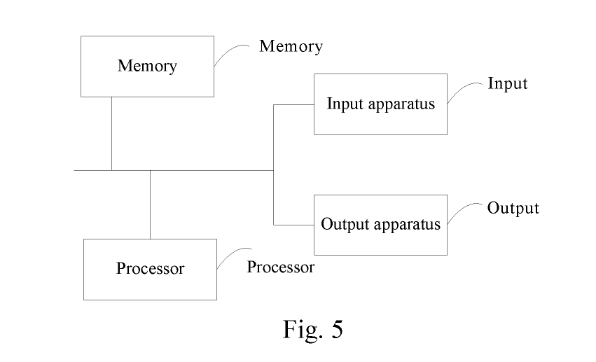

FIG. 5 is a schematic structural diagram of hardware of an electronic device for executing a domain name resolution method provided by Embodiment 6 of the disclosure.

As shown in FIG. 5, the device includes:
one or more processors Processor and a memory Memory, with one processor Processor as an example in FIG. 5.

A device for execute the domain name resolution method may further include: an input apparatus Input and an output apparatus Output.

The processor Processor, the memory Memory, the input apparatus Input, and the output apparatus Output can be connected by means of a bus or in other manners, with a connection by means of a bus as an example in FIG. 5.

As a non-volatile computer readable storage medium, the memory Memory can be used to store non-volatile software programs, non-volatile computer executable programs and modules, for example, program instructions/module corresponding to the method for processing a list item operation in the embodiments of the disclosure (for example, a request receiving module 310, a domain name and address acquisition module 320, a server selection module 330, and an address sending module 340 shown in FIG. 3). The processor Processor executes various functional applications and data processing of the server, that is, implements the domain name resolution method of the foregoing method embodiments, by running the non-volatile software programs, instructions, and modules stored in the memory Memory.

The memory Memory may include a program storage area and a data storage area, where the program storage area may store an operating system and at least one application needed by function; the data storage area may store data created according to use of the domain name resolution apparatus, and the like. In addition, the memory Memory may include a high-speed random access memory, and also may include a non-volatile memory, such as at least one disk storage device, flash storage device, or other non-volatile solid-state storage devices. In some embodiments, the memory Memory optionally includes memories remotely disposed with respect to the processor Processor, and the remote memories may be connected, via a network, to the domain name resolution apparatus. Examples of the foregoing network include but are not limited to: the Internet, an intranet, a local area network, a mobile communications network, and a combination thereof.

The input apparatus Input can receive entered digit or character information, and generate key signal inputs relevant to user setting and functional control of the domain name resolution apparatus. The output apparatus Output may include a display device, for example, a display screen, etc.

The one or more modules are stored in the memory Memory, and execute the domain name resolution method in any one of the foregoing method embodiments when being executed by the one or more processors Processor.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:
(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;
(2) Ultra mobile personal computer device: such devices belonging to a category of personal computers, having computing and processing functions, and also generally a feature of mobile Internet access; such type of terminals including PDA, MID and UMPC devices, and the like, for example, an iPad;
(3) Portable entertainment device: such devices being capable of display and play multimedia content; such type of devices including an audio and video player (for example, an iPod), a handheld game console, an e-book, an intelligent toy and a portable vehicle-mounted navigation device;
(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and
(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

We claim:

1. A domain name resolution method applied in a terminal, comprising:
receiving a domain name resolution request sent by a terminal device;
acquiring domain name information from the domain name resolution request and acquiring IP addresses of multiple servers corresponding to the domain name information;
selecting a server with a minimum load among the multiple servers; and
sending an IP address of the server with a minimum load to the terminal device, so that the terminal device accesses the server with a minimum load.

2. The method according to claim 1, wherein the selecting a server with a minimum load among the multiple servers comprises:
separately acquiring load capacities of the multiple servers from a predetermined monitoring server; and
selecting the server with a minimum load.

3. The method according to claim 2, wherein the load capacities are obtained by at least one of a download speed, a number of connected terminals, and a download response time.

4. A non-volatile computer storage medium, stored with computer executable instructions that, when executed by an electronic device, cause the electronic device to:
receive a domain name resolution request sent by a terminal device;
acquire domain name information from the domain name resolution request and acquire IP addresses of multiple servers corresponding to the domain name information;
select a server with a minimum load among the multiple servers; and
send an IP address of the server with a minimum load to the terminal device, so that the terminal device accesses the server with a minimum load.

5. An electronic device, comprising:
at least one processor; and
a memory in communication connection with the at least one processor, wherein
the memory stores instructions that can be executed by the at least one processor,
wherein execution of the instructions by the said at least one processor causes the at least one processor to:
receive a domain name resolution request sent by a terminal device;
acquire domain name information from the domain name resolution request and acquiring IP addresses of multiple servers corresponding to the domain name information;
select a server with a minimum load among the multiple servers; and
send an IP address of the server with a minimum load to the terminal device, so that the terminal device accesses the server with a minimum load.

6. The non-volatile computer storage medium according to claim 4, where in the selecting a server with a minimum load among the multiple servers cause the electronic device to:
separately acquire load capacities of the multiple servers from a predetermined monitoring server; and
select the server with a minimum load.

7. The non-volatile computer storage medium according to claim 6, wherein the load capacities are obtained by at least one of a download speed, a number of connected terminals, and a download response time.

8. The electronic device according to claim 5, where in the selecting a server with a minimum load among the multiple servers cause the electronic device to:
separately acquire load capacities of the multiple servers from a predetermined monitoring server; and
select the server with a minimum load.

9. The electronic device according to claim 8, wherein the load capacities are obtained by at least one of a download speed, a number of connected terminals, and a download response time.
